(19) United States
(12) Patent Application Publication
(10) Pub. No.: US 2024/0070636 A1
(43) Pub. Date: Feb. 29, 2024

(54) PRE-ENTRY FOR DISTRIBUTED TRANSACTIONS

(71) Applicant: Truist Bank, Charlotte, NC (US)

(72) Inventor: Stephen Gary Hess, Palm Springs, CA (US)

(73) Assignee: Truist Bank, Charlotte, NC (US)

(21) Appl. No.: 17/894,763

(22) Filed: Aug. 24, 2022

(51) Int. Cl. G06Q 20/10; G06Q 20/32; G06Q 20/40

(52) U.S. Cl. CPC G06Q 20/1085; G06Q 20/102; G06Q 20/3221; G06Q 20/3274; G06Q 20/3278; G06Q 20/40

(57) ABSTRACT

A computer-implemented method includes receiving a pre-entry request for a distributed transaction from a mobile device. The method also includes querying a bank server for permission to execute the distributed transaction. Additionally, the method includes issuing a completion code for the distributed transaction to the mobile device. Further, the method includes receiving the completion code at an automated teller machine (ATM) from the mobile device that verifies authorization of the ATM to complete the distributed transaction. Furthermore, the method includes actuating the ATM in compliance with the distributed transaction to complete the distributed transaction.

### TECHNICAL FIELD

The present disclosure relates generally to distributed transactions and, more particularly (although not necessarily exclusively), distributed transactions performed using transaction pre-entry information from remote devices.

### BACKGROUND

Automated teller machines (ATMs) are electronic devices that enable customers of financial institutions to perform financial transactions such as cash withdrawals, deposits, transfers of funds, balance inquiries, or other account information inquiries. ATMs may allow customers to perform such transactions at any time without the need for direct interaction with banking staff.

Mobile banking software provided by a financial institution may allow customers to conduct financial transactions remotely using computing devices such as smartphones or laptop computers. Transactions through mobile banking may include obtaining account balances, obtaining a list of latest transactions, electronic bill payments, remove check deposits, and fund transfers between customer accounts. But there is typically very little interaction between mobile banking software and the ATMs.

### SUMMARY

In an example, a non-transitory computer-readable medium includes instructions that are executable by a processing device for causing the processing device to perform operations. The operations include receiving a pre-entry request for a distributed transaction from a mobile device. The operations also include querying a bank server for permission to execute the distributed transaction. Additionally, the operations include issuing a completion code for the distributed transaction to the mobile device. Further, the operations include receiving the completion code at an automated teller machine (ATM) from the mobile device that verifies authorization of the ATM to complete the distributed transaction. Furthermore, the operations include actuating the ATM in compliance with the distributed transaction to complete the distributed transaction.

In an additional example, a computer-implemented method includes receiving a pre-entry request for a distributed transaction from a mobile device. The method also includes querying a bank server for permission to execute the distributed transaction. Additionally, the method includes issuing a completion code for the distributed transaction to the mobile device. Further, the method includes receiving the completion code at an automated teller machine (ATM) from the mobile device that verifies authorization of the ATM to complete the distributed transaction. Furthermore, the method includes actuating the ATM in compliance with the distributed transaction to complete the distributed transaction.

In an additional example, a system includes a processor and a non-transitory computer-readable medium including instructions that are executable by a processing device for causing the processing device to perform operations. The operations include receiving a pre-entry request for a distributed transaction from a mobile device. The operations also include querying a bank server for permission to execute the distributed transaction. Additionally, the operations include issuing a completion code for the distributed transaction to the mobile device. Further, the operations include receiving the completion code at an automated teller machine (ATM) from the mobile device that verifies authorization of the ATM to complete the distributed transaction. Furthermore, the operations include actuating the ATM in compliance with the distributed transaction to complete the distributed transaction.

### BRIEF DESCRIPTION OF THE DRAWINGS

FIG. 1 is a schematic of a banking environment in which a user can partially complete an automated teller machine (ATM) transaction with a computing device before finalizing the ATM transaction at a physical ATM according to one example of the present disclosure

FIG. 2 is a block diagram of an example computing device according to one example of the present disclosure.

FIG. 3 is a flowchart of an example of a process for implementing some aspects of the present disclosure.

FIG. 4 is an example of a user interface (UI) for a virtual assistant module, according to some aspects of the present disclosure.

FIG. 5 is an example of a UI for a virtual assistant module, according to some aspects of the present disclosure.

### DETAILED DESCRIPTION

Certain aspects and examples of the present disclosure relate to distributed transactions performed using transaction pre-entry information from remote devices. The transaction pre-entry of information may be populated at a personal electronic device and transmitted for use by automated teller machine (ATM) transactions. The pre-entry of information may involve partially completing an ATM transaction with a computing device before finalizing the ATM transaction at a physical ATM location. Partially completing an ATM transaction may include navigating a menu or selecting actions for an ATM to perform. Finalizing the ATM transaction may include any banking transaction that cannot be completed by a computing device, such as receiving physical cash. The computing device may be any device capable of electronic communication with a financial institution. Example computing devices may include smartphones and tablet computers.

Executing an ATM transaction, in person, from start to finish, can create several obstacles for a user. In person, a user may be susceptible to identity theft when entering or navigating personal financial information. Skimming, the theft of personal financial information from illegitimate payment card readers affixed to legitimate payment card readers, may be another risk of ATM transactions. Some ATMs may not offer accessibility options for particular disabilities. Some ATMs may simply be in physically inconvenient positions, such as drive-through ATMs which may require users to awkwardly position themselves to physically access push-buttons of the ATM.

Partially completing an ATM transaction through a computing device may mitigate some risks, inconveniences, and accessibility hurdles imposed by ATMs. For example, a visually impaired user may be able to complete button entries on a laptop computer or other computing device which may wirelessly communicate with an ATM to release train tickets. As another example, a banking customer using an ATM in a heavily trafficked area may execute a cash withdrawal with greater peace of mind by displaying a quick response (QR) code to a camera of an ATM rather than publicly displaying the amount of cash withdrawn by navigating a screen of an ATM or by using an ATM card or debit card at the ATM. As another example, a banking customer may prefer to navigate an ATM via a smartphone and receive cash by displaying a QR code to minimize time spent awkwardly positioning themselves within a vehicle that is either too tall or too short to comfortably interface with the buttons of an ATM.

In some examples, a computing device may allow a user to locate an ATM for completing an ATM transaction. The user may be able to enter commands through a variety of means. Examples may include virtual assistant software, voice commands, a smartphone application with a graphical user interface, a computing device with a refreshable braille display, or assistive input devices such as sip-and-puff systems or electronic pointing devices.

Example ATM transactions may include cash withdrawals, cash advances from lines of credits, purchasing stamps, purchasing ticks, cash deposits, cash payments to other parties, or printing receipts reflecting banking information.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

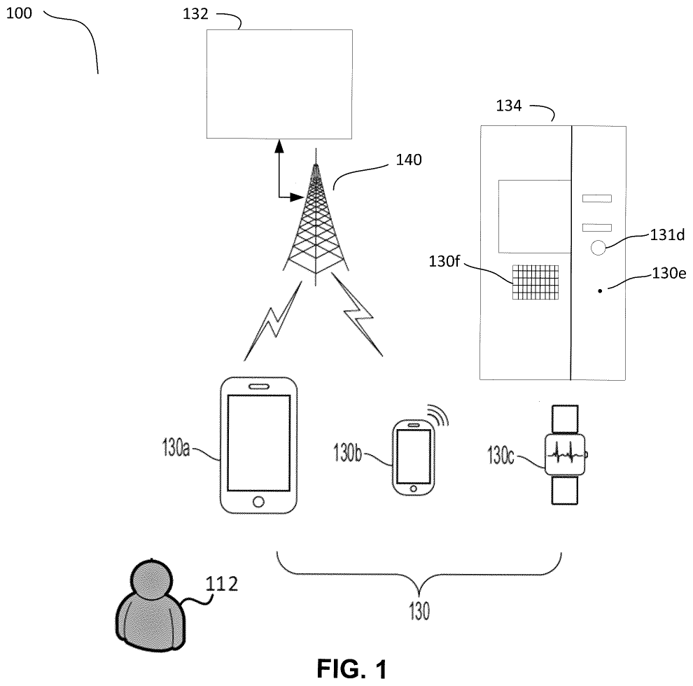

FIG. 1 is a schematic of a banking environment 100 in which a user 112 can partially complete an automated teller machine (ATM) transaction with a computing device before finalizing the ATM transaction at a physical ATM according to one example of the present disclosure. Included in the banking environment 100 are the user 112, one or more sensing devices 130, one or more communication networks 140, an ATM 134, and a computing device 132. The one or more sensing devices 130 and the ATM 134 may send or receive communication with the computing device 132 over the one or more communication networks 140. The one or more communication networks 140 may correspond to one or more Wide Area Networks (“WANs”), such as the Internet, through which the one or more sensing devices 130, the ATM 134, and the computing device 132 may communicate with servers via web browsers or client-side applications, to establish communication sessions, request and receive web-based resources, and access other features of applications or services. Although illustrated separate from the ATM 134 in the banking environment 100, in certain examples, the computing device 132 can be included within the ATM 134 and in other examples, the computing device 132 can be situated in a remote location away from the banking environment 100.

The one or more sensing devices 130, which can include suitable sensor devices for accessing web-based resources or application-based resources, can be capable of accessing and establishing communication sessions with the computing device 132 through the one or more communication networks 140. As illustrated in FIG. 1, sensing devices 130a-130c correspond to mobile devices, including tablet computers 130a, smartphones 130b, and smart watches 130c, which may access the computing device 132 via a Local Area Network (“LAN”) or Wide Area Network (“WAN”), as well as mobile telecommunication networks, short-range wireless networks, or various other communication network types (e.g., cable or satellite networks). Sensing devices 130d-130f correspond to sensing devices associated with the ATM, including an ATM camera 130d, an ATM microphone 130e, and an ATM keypad 130f. Although certain examples herein are described in terms of mobile devices, in other examples, the one or more sensing devices 130 may additionally or alternatively include other mobile or non-mobile devices (e.g., desktop computers, laptop computers, and the like) capable of accessing the computing device 132 via the one or more communications networks 140. The one or more sensing devices 130 and the ATM 134 can be capable of recording audio or video of an ATM operation.

The one or more sensing devices 130 can detect inputs from the user 112. The computing device 132 can receive notification of the inputs and determine an intent of the inputs from the one or more sensing devices 130. In some examples, the input to the received at the one or more sensing devices 130a-130c may be a transaction pre-entry for the ATM 134. For example, the computing device 132 can receive the input from the user 112 and transmit a transaction request associated with the input to the ATM 134. The ATM 134 may pre-process the request and await the arrival of the user 112 at the physical location of the ATM 134. Once the user 112 reaches the ATM 134, the user may present a QR code identifying the user 112, and the ATM 134 may automatically complete the ATM transaction requested by the user at the sensing device 130a-130c. In additional examples, the ATM 134 may confirm the identity of the user 112 through other techniques, such as facial recognition, voice recognition, or any other identification techniques.

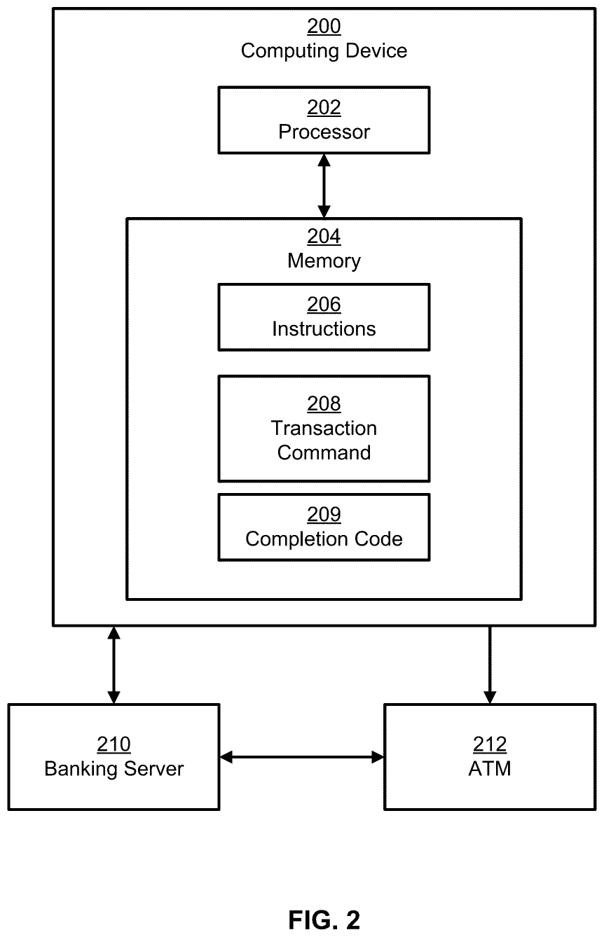

FIG. 2 is a block diagram of an example computing device according to one example of the present disclosure. The computing device 200 includes a processor 202 that is communicatively coupled to a memory 204. In some examples, the processor 202 and the memory 204 may be distributed from (e.g., remote to) one another. The processor 202 can include one processing device or multiple processing devices. Non-limiting examples of the processor 202 include a Field-Programmable Gate Array (FPGA), an application-specific integrated circuit (ASIC), a microprocessor, etc. The processor 202 can execute instructions 206 stored in the memory 204 to perform operations. In some examples, the instructions 206 can include processor-specific instructions generated by a compiler or an interpreter from code written in a suitable computer-programming language, such as C, C++, C #, etc.

The memory 204 can include one memory or multiple memories. The memory 204 can be non-volatile and may include any type of memory that retains stored information when powered off. Non-limiting examples of the memory 204 include electrically erasable and programmable read-only memory (EEPROM), flash memory, or any other type of non-volatile memory. At least some of the memory 204 can include a non-transitory, computer-readable medium form which the processor 202 can read instructions 206. The memory 204 may also include transaction commands received from the user 112 for controlling an ATM 212 through, for example, a banking server 210. In some examples, the memory 204 may also store a completion code 209 that the user 112 may present to the ATM 212 to complete a distributed transaction. The computer-readable medium of the memory 204 can include electronic, optical, magnetic, or other storage devices capable of providing the processor 202 with computer-readable instructions or other program code. Non-limiting examples of a computer-readable medium include magnetic disk(s), memory chip(s), ROM, random-access memory (RAM), an ASIC, a configured processor, optical storage, or any other medium from which a computer processor can read the instructions 206. The computing device 200 may be in operable communication with an automated teller machine (ATM) 212.

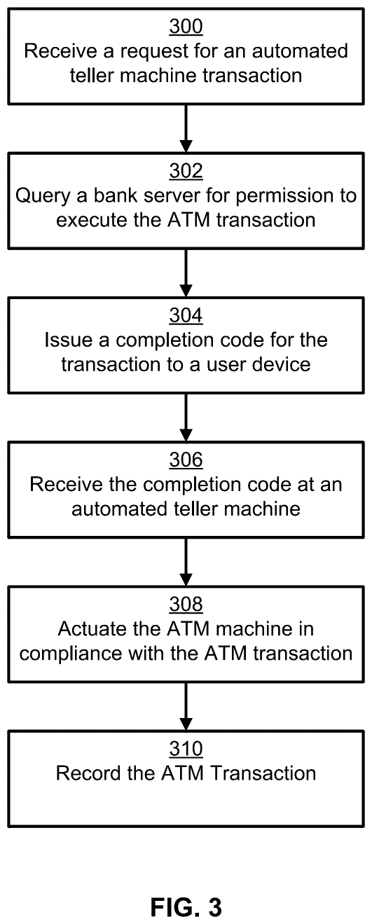

FIG. 3 is a flowchart of an example of a process for implementing some aspects of the present disclosure. In block 300, the computing device 200 may receive an automated teller machine (ATM) transaction command 208 from a mobile device, such as the computing device 200. The transaction command 208 may be to fulfil an electronic bill payment with a cash deposit, a check deposit, or some other suitable type of deposit. The transaction command 208 may be to withdraw cash from any account or deposit cash into any account. The transaction command 208 may be a request for a cash advance from a line of credit, such as a cred it card. The transaction command 208 may be to withdraw a non-monetary physical item from the ATM. Example non-monetary physical items that can be withdrawn from an ATM may include postage stamps, train tickets, plane tickets, event tickets, lottery tickets, gold, silver, or tokens such as poker chips. The transaction command 208 may also be for obtaining travelers checks. The transaction command 208 may be for issuing a money order.

In block 302, the computing device 200 may query a banking server 210 for permission to execute the transaction command 208. The banking server 210 may grant or withhold permission to execute the transaction command 208 based on information related to a banking customer associated with the transaction command 208. For example, the banking server 210 may grant or withhold permission to execute the transaction command 208 based on an account balance or a credit limit of the customer. The banking server 210 may grant or withhold permission to execute the transaction command 208 based on the functionality of an ATM 212. For example, the banking server 210 may withhold permission to execute the transaction command 208 if the transaction command 208 is for purchasing postage stamps at an ATM 212 that does not sell postage stamps. The banking server 210 may also provide the computing device 200 with locations of ATMs suitable for executing a particular transaction command.

In block 304, the banking server 210 may issue a completion code 209 for the transaction command 208 to the computing device 200. The completion code 209 may be a quick response (QR) code for scanning by a camera of the ATM 212. The completion code 209 may be a barcode for scanning by a camera or laser of the ATM 212. The completion code 209 may be a near field communication (NFC) protocol wireless communication with the ATM 212. The completion code 209 may be any other suitable wireless radio frequency communication with the ATM 212. The completion code 209 may be a numerical code. In some examples, the completion code may be facial recognition or other biometric recognition of the user at the ATM 212.

In block 306, the banking server 210 may receive the completion code 209 at the ATM 212. Reception of the code may be confirmed by global positioning system (GPS) data provided by the computing device 200 based on the location of the computing device 200. In some examples, the ATM 212 may receive the completion code 209 without communicating with the banking server 210.

In block 308, the ATM 212 may actuate in compliance with the transaction command 208. The ATM 212 may dispense cash, dispense traveler's checks, dispense non-monetary physical goods, accept cash, execute transfers of funds, accept bills, print receipts, or perform any other action or series of actions to satisfy the transaction command 208.

In block 310, the banking server 210 or the ATM 212 may record execution of the transaction command 208. The banking server 210 may send an email, text message, or a message through a virtual assistant confirming the transaction to the computing device 200. The ATM 212 may also print a receipt of the transaction.

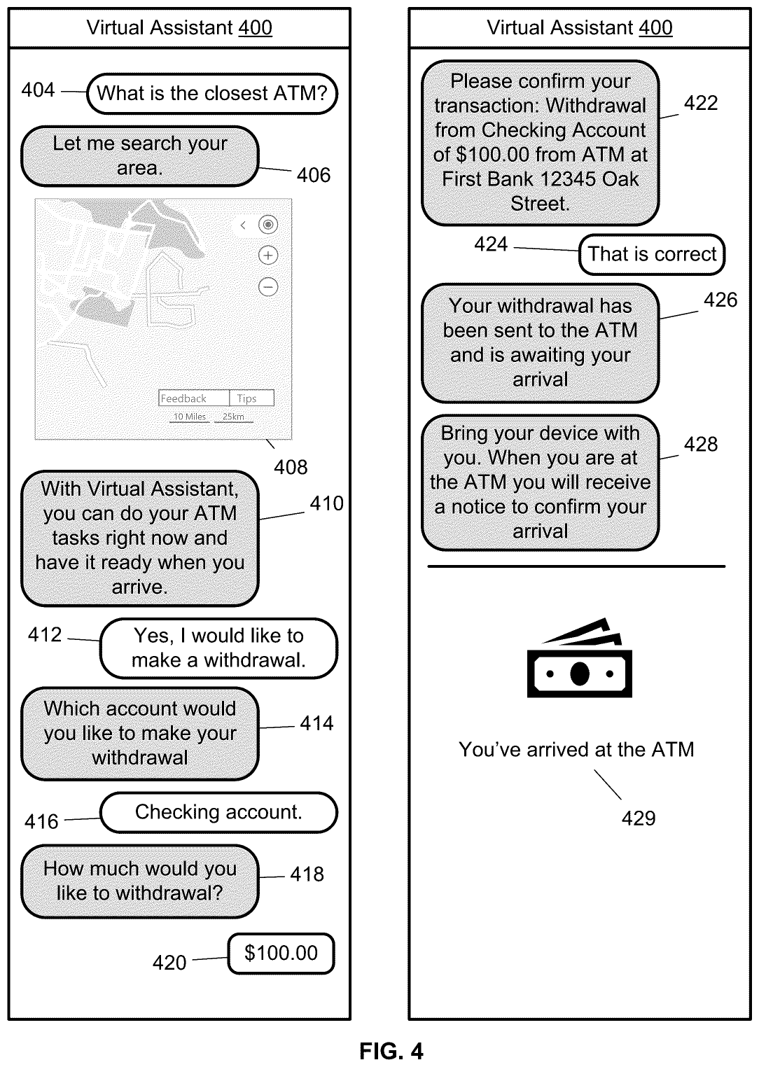

FIG. 4 is an example of a user interface (UI) for a virtual assistant module 400, according to some aspects of the present disclosure. The virtual assistant module 400 may be displayed on a computing device, such as a display of the computing device 200. At block 404, a user asks the virtual assistant 400 where the closest ATM is. The virtual assistant 400 responds 406 with a message informing the user that the virtual assistant 400 is executing a search. Messages informing the user a search, or any other process, is underway may assure the user the virtual assistant is operational. The virtual assistant 400 provides a map 408 displaying the nearest ATM relative to the user's mobile device. The virtual assistant may inform 410 the user that pre-entry is compatible with this particular ATM.

The user may request 412 an ATM operation to initiate a pre-entry process. The virtual assistant 400 may ask the user questions 414, 418, 422 to complete the pre-entry process. The user may respond 416, 420, 424 to the questions to complete the pre-entry process. In alternative examples, the user may complete the pre-entry process with a process consisting of more questions, less questions, or different questions. In alternative examples, the user may complete the pre-entry process with an alternative user interface that may use icons, drop-down menus, or any combination of suitable user interface items. Further, the user may enter responses to the virtual assistant questions using voice instructions received at a microphone of a computing device displaying the virtual assistant 400.

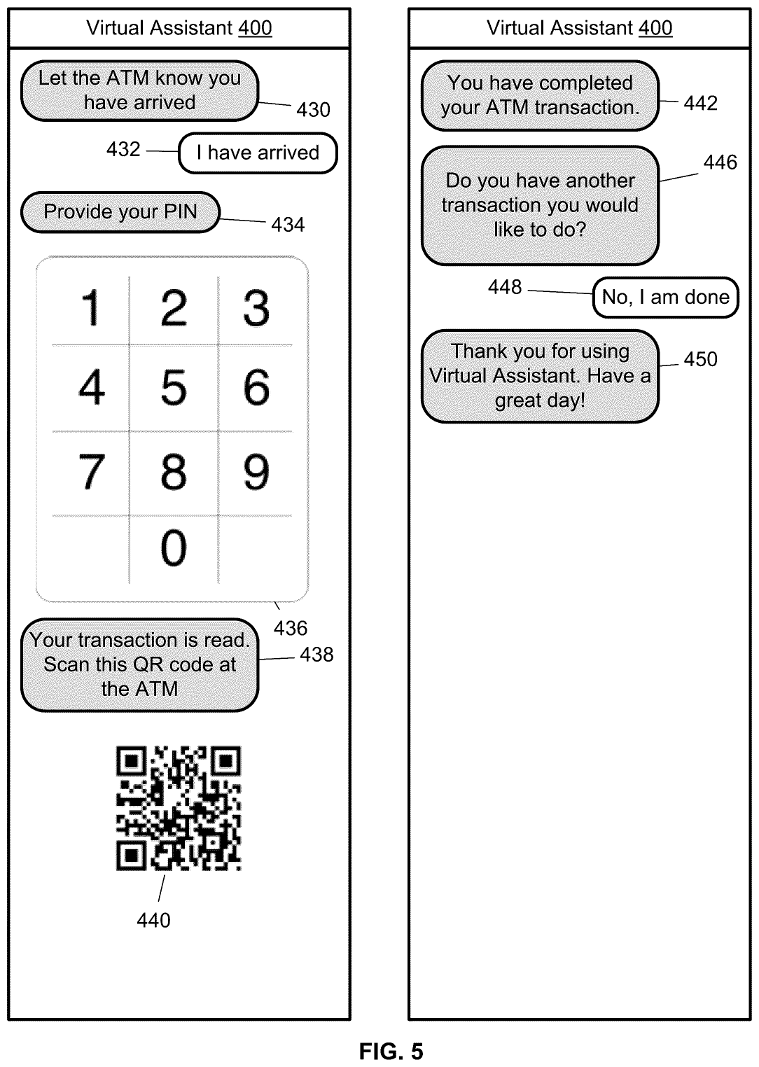

The virtual assistant 400 may inform 426 the user an ATM has received pre-entry instructions, may remind 428 the user to bring their mobile device, and may inform 429 the user their mobile device is near the ATM. The example process continues in FIG. 5.

FIG. 5 is an example of a UI for the virtual assistant module 400, according to some aspects of the present disclosure. FIG. 5 is an extension of the example illustrated in FIG. 4. The virtual assistant 400 may provide instructions 430, 434 to the user after the user has arrived at the ATM. The virtual assistant 400 may prompt 436 the user to enter personal information to complete the ATM transaction. While a numerical keypad is illustrated, other forms of entering personal information are possible, such as gesture recognition, facial recognition, or any combination of suitable means. The virtual assistant 400 may prompt 438 the user to present a quick response (QR) code 440 to the ATM. The QR code 440 may serve as a means of instructing the ATM. Other means of passing instructions from the user's mobile device to the ATM are also possible, such as near-field communication.

The virtual assistant 400 may inform 442 the user the transaction has been completed, ask 446 the user if they would like to perform any other ATM transactions, and conclude 450 the interaction with an appropriate message.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A non-transitory computer-readable medium comprising instructions that are executable by a processing device for causing the processing device to:
receive a pre-entry request for a distributed transaction from a mobile device;
query a bank server for permission to execute the distributed transaction;
issue a completion code for the distributed transaction to the mobile device;
receive the completion code at an automated teller machine (ATM) from the mobile device that verifies authorization of the ATM to complete the distributed transaction;
actuate the ATM in compliance with the distributed transaction to complete the distributed transaction.

2. The non-transitory computer-readable medium of claim 1, wherein the completion code comprises a quick response (QR) code for scanning by a camera of the ATM.

3. The non-transitory computer-readable medium of claim 1, wherein the completion code comprises relayed to the ATM via a near field communication (NFC) protocol.

4. The non-transitory computer-readable medium of claim 1, wherein the distributed transaction comprises an electronic bill payment fulfilled by a cash deposit made at the ATM.

5. The non-transitory computer-readable medium of claim 1, wherein the distributed transaction comprises a cash withdraw from a checking account.

6. The non-transitory computer-readable medium of claim 1, wherein the distributed transaction comprises a cash advance from a line of credit.

7. The non-transitory computer-readable medium of claim 1, wherein the distributed transaction comprises withdrawing a non-monetary physical item from the ATM.

8. A computer-implemented method comprising:
receiving a pre-entry request for a distributed transaction from a mobile device;
querying a bank server for permission to execute the distributed transaction;
issuing a completion code for the distributed transaction to the mobile device;
receiving the completion code at an automated teller machine (ATM) from the mobile device that verifies authorization of the ATM to complete the distributed transaction;
actuating the ATM in compliance with the distributed transaction to complete the distributed transaction.

9. The computer-implemented method of claim 8, wherein the completion code comprises a quick response (QR) code displayed for scanning by a camera of the ATM.

10. The computer-implemented method of claim 8, wherein the completion code is received at the ATM via a near field communication (NFC) protocol.

11. The computer-implemented method of claim 8, wherein the distributed transaction comprises an electronic bill payment fulfilled by a cash deposit made at the ATM.

12. The computer-implemented method of claim 8, wherein the distributed transaction comprises a cash withdraw from a checking account.

13. The computer-implemented method of claim 8, wherein the distributed transaction comprises a cash advance from a line of credit.

14. The computer-implemented method of claim 8, wherein the distributed transaction comprises withdrawing a non-monetary physical item from the ATM.

15. A system comprising:
a processor; and
a non-transitory computer-readable medium comprising instructions that are executable by a processing device for causing the processing device to:
receive a request for distributed transaction from a mobile device;
query a bank server for permission to execute the distributed transaction;
issue a completion code for the distributed transaction to the mobile device;
receive the completion code at an automated teller machine (ATM) from the mobile device that verifies authorization of the ATM to complete the distributed transaction;
actuate the ATM in compliance with the distributed transaction to complete the distributed transaction.

16. The non-transitory computer-readable medium of claim 15, wherein the completion code comprises a quick response (QR) code displayed on the mobile device and scanned by a camera of the ATM.

17. The non-transitory computer-readable medium of claim 15, wherein the completion code is received at the ATM via a near field communication (NFC) protocol.

18. The non-transitory computer-readable medium of claim 15, wherein the distributed transaction comprises an electronic bill payment fulfilled by a cash deposit made at the ATM.

19. The non-transitory computer-readable medium of claim 15, wherein the distributed transaction comprises a cash withdraw from a checking account.

20. The non-transitory computer-readable medium of claim 15, wherein the distributed transaction comprises a cash advance from a line of credit.
